(19) United States
(12) Patent Application Publication
(10) Pub. No.: US 2017/0083365 A1
(43) Pub. Date: Mar. 23, 2017

(54) Adaptive Chunk Size Tuning for Data Parallel Processing on Multi-core Architecture

(71) Applicant: QUALCOMM Incorporated, San Diego, CA (US)

(72) Inventors: Han Zhao, Santa Clara, CA (US); Arun Raman, Fremont, CA (US); Pablo Montesinos Ortego, Fremont, CA (US)

(21) Appl. No.: 14/862,398

(22) Filed: Sep. 23, 2015

(51) Int. Cl. G06F 9/48; G06F 9/46

(52) U.S. Cl. CPC G06F 9/4881; G06F 9/465

(57) ABSTRACT

Methods, devices, and non-transitory process-readable storage media for dynamically adapting a frequency for detecting work-stealing operations in a multi-processor computing device. A method according to various embodiments and performed by a processor includes determining whether any work items of a cooperative task have been reassigned from a first processing unit to a second processing unit, calculating a chunk size using a default equation in response to determining that no work items of the cooperative task have been reassigned from the first processing unit, calculating the chunk size using a victim equation in response to determining that one or more work items of the cooperative task have been reassigned from the first processing unit, and executing a set of work items of the cooperative task that correspond to the calculated chunk size.

### BACKGROUND

Data parallel processing is a technique for splitting general computations into smaller segments of work that can be executed by various processing units of a multi-processor computing device. Some data parallel processing frameworks employ a task-based runtime system to manage and coordinate the execution of data parallel programs or tasks (e.g., executable code). For example, in a multi-core device (e.g., a heterogeneous system-on-chip (SOC)), a runtime system may launch the same task on various cores so that each core can process different, independent work items and cooperatively complete the overall work. Conventional data parallel processing techniques can utilize dynamic load balancing schemes, such as “work-stealing” policies that reassign work items from busy processing units to available processing units. For example, a first task on a first core that has finished an assigned set of iterations of a parallel loop task may receive iterations originally assigned to a second task executing on a second core.

Each processing unit (or associated routines) participating in a work-stealing environment is typically configured to periodically check whether other processing units have received (or “stolen”) work items originally assigned to that processing unit. Such checking operations are relatively resource intensive, requiring non-negligible atomic operation costs. Typically, the frequency for a processing unit (or associated routines) to conduct such checking operations is measured in a number of work items (i.e., a “chunk” of work items). The size of a chunk (i.e., the number of work items after which checking operations are performed) can impact the performance and efficiency of data parallel processing. For example, although smaller chunk sizes may result in more frequent opportunities to detect stealing or reassignment occurrences (hence better workload balancing result), performance of a multi-processor computing device can be degraded because costly checks are performed too frequently.

### SUMMARY

Various embodiments provide methods, devices, systems, and non-transitory process-readable storage media for dynamically adapting a frequency for detecting work-stealing occurrences in a multi-processor computing device. An embodiment method performed by a processor of the multi-processor computing device may include determining whether any work items of a cooperative task have been reassigned from a first processing unit to a second processing unit. The embodiment method may include calculating a chunk size using a default equation in response to determining that no work items of the cooperative task have been reassigned from the first processing unit to the second processing unit. The embodiment method may include calculating a chunk size using a victim equation in response to determining that one or more work items of the cooperative task have been reassigned from the first processing unit to the second processing unit. The embodiment method may include executing a set of work items of the cooperative task that correspond to the calculated chunk size.

In some embodiments, the default equation may be:

$${T}^{′} = \frac{T}{x} ,$$

where T′ represents the chunk size, T represents a previously calculated chunk size, and x is a non-zero value.

In some embodiments, the default equation may be:

$${T}^{′} = \frac{m}{( x \cdot {2}^{n} )} ,$$

where T′ represents the chunk size, m represents a total number of work items assigned to the first processing unit, x is a non-zero value, and n is a counter representing a number of times the chunk size has been calculated for the first processing unit for the cooperative task.

In some embodiments, n may represent a total number of processing units executing work items of the cooperative task.

In some embodiments, the victim equation may be:

$${T}^{′} = int ( \frac{q}{p} * T ) ,$$

where T′ represents a new chunk size, int( ) represents a function that returns an integer value, T represents a previously-calculated chunk size, p represents a total number of remaining work items to be processed before a reassignment operation occurs, and q represents a number of remaining work items after the reassignment operation.

In some embodiments, the cooperative task may be a parallel loop task. In some embodiments, the multi-processor computing device may be a heterogeneous multi-processor computing device that includes two or more of a first central processing unit (CPU), a second central processing unit (CPU), a graphics processing unit (GPU), and a digital signal processor (DSP). In some embodiments, the first processing unit and the second processing unit are the same processing unit that is executing two or more procedures that are each assigned different work items of the cooperative task.

Further embodiments include a computing device configured with processor-executable instructions for performing operations of the methods described above. Further embodiments include a non-transitory processor-readable medium on which is stored processor-executable instructions configured to cause a computing device to perform operations of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the claims.

FIG. 1 is a component block diagram illustrating task queues and processing units of an exemplary multi-processor computing device suitable for use in various embodiments.

FIGS. 2A-2H are functional block diagrams illustrating a scenario in which a multi-processor computing device performs efficient stealing-detection operations based on dynamic chunk sizes according to various embodiments.

FIG. 3 is a process flow diagram illustrating an embodiment method for a multi-processor computing device to calculate chunk sizes for performing stealing-detection operations for a processing unit.

FIG. 4 is a component block diagram of a mobile computing device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the embodiments or the claims.

Various embodiments provide methods that may be implemented on multi-processor computing devices for dynamically adapting the frequency at which a multi-processor computing device performs stealing-detection operations depending upon whether work items have been stolen by (i.e., reassigned to) other processing units. Methods of various embodiments provide protocols for configuring processing units (and associated tasks) to use dynamically adjusted frequencies (i.e., reducing chunk sizes) for determining whether work items have been stolen or reassigned to other processing units. The word “exemplary” is used herein to mean “serving as an example, instance, or illustration.” Any implementation described herein as “exemplary” is not necessarily to be construed as preferred or advantageous over other implementations.

The term “computing device” is used herein to refer to an electronic device equipped with at least a multi-core processor. Examples of computing devices may include mobile devices (e.g., cellular telephones, wearable devices, smart-phones, web-pads, tablet computers, Internet enabled cellular telephones, Wi-Fi® enabled electronic devices, personal data assistants (PDA's), laptop computers, etc.), personal computers, and server computing devices. In various embodiments, computing devices with multiple processors and/or processor cores and various memory and/or data storage units.

The terms “multi-processor computing device” and “multi-core computing device” are used herein to refer to computing devices configured with two or more processing units. Multi-processor computing devices may execute various operations (e.g., routines, functions, tasks, calculations, instruction sets, etc.) using two or more processing units. A “homogeneous multi-processor computing device” may be a multi-processor computing device (e.g., a system-on-chip (SoC)) with a plurality of the same type of processing unit, each configured to perform workloads. A “heterogeneous multi-processor computing device” may be a multi-processor computing device (e.g., a heterogeneous system-on-chip (SoC)) with different types of processing units that may each be configured to perform specialized and/or general-purpose workloads. Processing units of multi-processor computing devices may include various processor devices, a core, a plurality of cores, etc. For example, processing units of a heterogeneous multi-processor computing device may include an application processor(s) (e.g., a central processing unit (CPU)) and/or specialized processing devices, such as a graphics processing unit (GPU) and a digital signal processor (DSP), any of which may include one or more internal cores. As another example, a heterogeneous multi-processor computing device may include a mixed cluster of big and little cores (e.g., ARM big.LITTLE architecture, etc.) and various heterogeneous systems/devices (e.g., GPU, DSP, etc.).

The terms “work-ready processor” and “work-ready processors” are generally used herein to refer to processing units and/or a tasks executing on the processing units that are ready to receive workload(s) via a work-stealing policy. For example, a “work-ready processor” may be a processing unit capable of receiving individual work items and/or tasks from other processing units or tasks executing on the other processing units. Similarly, the term “victim processor(s)” is generally used herein to refer to a processing unit and/or a task executing on the processing unit that has one or more workloads (e.g., individual work item(s), task(s), etc.) that may be transferred to one or more work-ready processors. In general, the victim or work-ready status of a processing unit may change over time (e.g., during processing of various chunks of a cooperative task, etc.). For example, a processing unit and/or task executing on a processing unit may be a victim processor at a first time, and once all assigned work items are completed, the processing unit and/or task executing on the processing unit may begin functioning as a work-ready processor that is configured to steal workloads from other processing units/tasks. Such terms are not intended to limit any embodiments or claims to specific types of processors.

In general, work stealing can be implemented in various ways, depending on the nature of the computing system. For example, a shared memory multi-processor system may employ a shared data structure (e.g., a tree representation of the work sub-ranges) to represent the sub-division of work across the processing units. In such a system, stealing may require work-ready processors to concurrently access and update the shared data structure via locks or atomic operations. As another example, a processing unit may utilize associated work-queues such that, when the queues are empty, the processing unit may steal work items from another processing unit and add the stolen work items to the work queues of the first processing unit. In a similar manner, another processing unit may steal work items from the first processing unit's work-queues. Conventional work-stealing schemes are often rather simplistic, such as merely enabling one processing unit to share (or steal) an equally-subdivided range of a workload from a victim processing unit.

With some parallel processing implementations, a multi-processor computing device may utilize shared memory. Work-stealing protocols may utilize a shared work-stealing data structure to (e.g., a work-stealing tree data structure, etc.) that describes the processor (or task) that is responsible for certain ranges of work items of a certain shared task. In typical cases, locks may be employed to restrict access to certain data within the shared memory, such as the work-stealing data structure. While in control of (or having ownership over) a lock, a work-ready processor may directly steal work from a victim processor by adjusting or otherwise accessing data within the work-stealing data structure. In some cases, the multi-processor computing device may utilize hardware-specific atomic operations to enable lock-free implementations.

In conventional work-stealing implementations, the frequency at which performing stealing-detection operations are performed is fixed across all processing units (and associated tasks). Such set frequencies or chunk sizes may be set based on inputs from programmers, who often have no idea of how large the chunk size should be. It is also unlikely programmers can identify the optimal chunk size for a shared task (e.g., a cooperative parallel loop task), as tuning spaces the programmers need to sweep are often large and the optimal chunk size typically varies for different architectures. Improperly set or static frequencies for performing stealing-detection operations can negate the benefits of data parallel processing.

To improve the performance of processing units in a work-stealing, parallel-processing environment, various embodiments provide methods that may be implemented on computing devices, and stored on non-transitory process-readable storage media, for dynamically adapting the frequency at which a multi-processor computing device performs stealing-detection operations. In general, the multi-processor computing device may continually adjust the number of work items (i.e., the “chunk size”) a processing unit processes before performing checks to determine whether another processing unit has “stolen” work from the processing unit. For example, the multi-processor computing device may calculate the number of iterations of a parallel loop task that a GPU should execute prior to determining whether other iterations have been reassigned to a DSP. With dynamic chunk sizes based on progress with regard to a cooperative task, methods according to various embodiments schedule stealing-detection operations at frequencies that balance efficient execution with victim status awareness of the processing units.

In general, the probability of a reassignment operation (i.e., stealing) occurring increases over time during the execution of a cooperative processing effort or task. For example, at the beginning of a parallel loop task shared amongst a plurality of processing units (e.g., cores), the probability of task stealing is low because all of the processing units have just begun respective workloads. However, after processing one or more chunks of work items, the processing units may become closer to completing respective workloads and thus may be closer to being able to steal work from others (i.e., “work-ready”). As the probability of stealing increases over time, the number of work items comprising a chunk for the processing units may continually decrease (i.e., calculate smaller and smaller chunk sizes), thus increasing the frequency that stealing-detection operations may be performed for the processing units.

Before detecting a reassignment (i.e., stealing) of work items to one or more other processors, the multi-processor computing device may configure a processing unit (or associated routines) to use a progressive “default” frequency for performing stealing-detection operations. In particular, prior to the processing unit becoming a “victim”, the multi-processor computing device may reduce a chunk size for the processing unit by a certain amount after each chunk of work items is completed by the processing unit. By reducing the chunk size, the frequency for performing stealing-detection operations increases. For example, after each check that determines that no work items have been stolen from a processing unit, the multi-processor computing device may reduce a chunk size for that processing unit by half. As another example, a chunk size for a processing unit may initially be set at a default chunk size of x work items and may be subsequently reduced over time to chunk sizes of x/2, x/4, and x/8 work items. In various embodiments, the lower bound for a chunk size may be 1 work item. For example, the multi-processor computing device may continually reduce a chunk size for a processing unit until the chunk size is 1. By configuring processing units to process fewer and fewer work items in between performing stealing-detection operations, the multi-processor computing device may tie the use of cost-prohibitive checking to the probability of stealing occurrences that increases over time.

In some embodiments, the multi-processor computing device may use various “default” equations to calculate chunk sizes, and thus define the frequency for performing stealing-detection operations before stealing has occurred regarding a processing unit. For example, chunk sizes may be calculated using the following default equation:

$${T}^{′} = int ( \frac{T}{x} ) , \qquad Equation 1 A$$

where T′ may represent a new chunk size for a processing unit, int( ) may represent a function that returns an integer value (e.g., floor( ), ceiling( ), round( ), etc.), T may represent the previously calculated chunk size for the processing unit, and x may represent a non-zero float or integer value (e.g., 2, 3, 4, etc.) greater than one.

As another example, chunk sizes may be calculated using the following default equation:

$${T}^{′} = int ( \frac{m}{( x * {2}^{n} )} ) , \qquad Equation 1 B$$

where T′ may represent a new chunk size for a processing unit, int( ) may represent a function that returns an integer value (e.g., floor( ), ceiling( ), round( ), etc.), m may represent the total number of work items assigned to the processing unit for a particular task, x may represent a static, non-zero value (e.g., a total number of processing units executing work items of a cooperative task, etc.), and n may represent an increasing counter for a number of times a chunk size has been calculated for the processing unit for the particular task (e.g., a parallel loop task).

The following is a non-limiting illustration of the multi-processor computing device using a default equation to calculate chunk sizes that define a default frequency for performing stealing-detection operations. At an initial time, a first processing unit may be assigned 100 work items related to a cooperative task shared by a plurality of processing units. An initial chunk size may be set at a size of 8 work items. The first processing unit may begin processing work items at a first time. The first processing unit may complete processing the 8 work items at a second time and then perform a stealing-detection operation to determine whether a reassignment operation (i.e., stealing) has occurred. If no stealing has occurred, a second chunk size may be calculated to be a size of 4 work items using the default equation (e.g., chunk size=half of the previous chunk size). The first processing unit may complete processing the 4 work items at a third time and then perform another stealing-detection operation to determine whether a reassignment operation (i.e., stealing) has occurred. If no stealing has occurred, a third chunk size may be calculated to be a size of 2 work items using the default equation. The first processing unit may complete processing the 2 work items at a fourth time and then perform another stealing-detection operation to determine whether a reassignment operation (i.e., stealing) has occurred. If no stealing has occurred, a fourth chunk size may be calculated to be a size of 1 work item using the default equation. The first processing unit may continue processing work items using a chunk size of 1 until the cooperative task is complete (and/or the first processing unit's task queue is empty).

In various embodiments, after the multi-processor computing device detects that reassignment operations (i.e., stealing operations) have occurred that removed work items from a processing unit's task queue, that processing unit may be considered a victim processor. As a result, the multi-processor computing device may use a progressive victim frequency for performing subsequent stealing-detection operations for the victim processor. Similar to the default frequency described, using such a victim frequency may cause the multi-processor computing device to continually increase the frequency of stealing-detection operations with regard to a particular processing unit. In particular, new chunk sizes for the victim processor may be calculated that reflect the complete progress of the victim processor without being so small that the victim processor pays a large checking overhead. Further, chunk sizes according to the victim frequency may be calculated to be small enough to enable timely detection of reassignment operations (i.e., stealing) and thus avoid executing redundant work items.

In some embodiments, the multi-processor computing device may use various “victim” equations to calculate chunk sizes and thus define the frequency for performing stealing-detection operations after stealing has occurred regarding a processing unit. For example, chunk sizes may be calculated using the following victim equation:

$${T}^{′} = int ( \frac{q}{p} * T ) , \qquad Equation 2$$

where T′ may represent a current (or new) chunk size, int( ) may represent a function that returns an integer value (e.g., floor( ), ceiling( ), round( ), etc.), T may represent a previously-calculated chunk size, p may represent the total number of remaining work items (or iterations) to be processed before the stealing happens, and q may represent the remaining work items (or iterations) after stealing (i.e., after a reassignment). In this way, T′ may reflect the complete progress of the victim processor at the time of a reassignment operation (i.e., stealing). In various embodiments, the lower bound for a chunk size calculated using a victim equation may be 1 work item.

In some embodiments, the multi-processor computing device may determine the total number of remaining work items (or iterations) p one time for each chunk processed (i.e., at the beginning of starting to process a set of work items defined by the current chunk size). For example, before and during processing a chunk of 20 work items, p may be 100, and only when the chunk is processed may the multi-processor computing device update p to a new value (e.g., 80). In other words, although work-ready processors may be able to steal at any time, a victim processor may only update p when checking for stolen status at the end of each processed chunk (i.e., before beginning processing of a new chunk of work items).

After a processing unit processes a chunk of work items, the relationship between the total number of remaining work items (or iterations) to be processed before a stealing happens, p, and the remaining work items (or iterations) after the stealing, q, may correspond to the size of the chunk that was just processed, x, and the number of work items stolen during that chunk, y. For example, when the multi-processor computing device performs stealing-detection operations for a first processing unit, the difference between the total number of remaining work items to be processed before the stealing happens (p) and the remaining work items after stealing (q) may be the same as the sum of the chunk size for the previous chunk (x) and the number of work items that were stolen during processing of the previous chunk (y) (i.e., (p-q)=(x+y)). Thus, the multi-processor computing device may use an alternative victim equation to calculate chunk sizes after stealing has occurred as follows:

$${T}^{′} = int ( \frac{p - x - y}{p} * T ) , \qquad Equation 3$$

where T′ represents a current (or new) chunk size, int( ) may represents a function that returns an integer value (e.g., floor( ), ceiling( ), round( ), etc.), T represents a previously-calculated chunk size, p represents the total number of remaining work items (or iterations) to be processed before stealing happens, x represents a previous chunk size, and y s represents a number of work items (or iterations) stolen during processing of the previous chunk.

The following is a non-limiting example of using Equation 2. At an initial time, a first processor may have 100 work times to process (i.e., p=100), and may have an initial chunk size of 20 (i.e., x=20). At a second time, the first processor may start to check for stealing activities after completing the first chunk (i.e., after completing 20 work items). At the second time, the first processor may determine that a second processor stole 40 work items (i.e., y=40) from the first processor, leaving 40 remaining work items for the first processor (i.e., q=40). When the first processor starts to process the remaining 40 work items, a new chunk size may be calculated using the Equation 2 as follows:

$${T}^{′} = int ( \frac{q}{p} * T ) = int ( \frac{40}{100} * 20 ) = 8.$$

The first processor may then start processing a new chunk of 8 work items. At a third time after the first processor completes processing of the 8 work items, stealing-detection operations may be performed. If no stealing from the first processor occurred in between the second and the third times, the first processor may calculate a new chunk size using a default equation (i.e., Equation 1A or Equation 1B). However, if another stealing from the first processor occurred in between the second and the third times, the first processor may calculate a new chunk size using the victim equation (i.e., Equation 2). The first processor may continue processing chunks and calculating new chunk sizes using the default or victim equations until the chunk size becomes 1 work item.

The following is a non-limiting illustration of the multi-processor computing device using a default equation and a victim equation to calculate chunk sizes that define a default frequency for performing stealing-detection operations. At an initial time, a first processing unit may be assigned 100 work items related to a cooperative task shared by a plurality of processing units. An initial chunk size may be set at 10 work items. The first processing unit may begin processing work items at a first time. The first processing unit may complete processing the 10 work items at a second time and then perform a stealing-detection operation to determine whether a reassignment operation (i.e., stealing) has occurred. If no stealing has occurred, a second chunk size may be calculated to be a size of 5 work items using the default equation (e.g., chunk size=half of the previous chunk size). The first processing unit may complete processing the 5 work items (e.g., a total of 15 completed work items) at a third time and then perform another stealing-detection operation to determine whether a reassignment operation (i.e., stealing) has occurred. At the third time, a reassignment operation (i.e., stealing) may be detected wherein a second processing unit is determined to have stolen 10 work items from the first processing unit. The first processing unit may be considered a victim processor at the third time. Thus, a third chunk size may be calculated using the victim equation (e.g., Equation 2), such that the third chunk size is calculated as follows:

$${T}^{′} = int ( \frac{q}{p} * T ) = int ( \frac{75}{85} * 5 ) = 4 ,$$

where T is the chunk size (5) for the chunk during which a stealing occurred, p is the number of remaining work items before the stealing (i.e., p=85), q is the number of remaining work items after the stealing of the 10 work items by the second processing unit (q=85−10=75), and T′ is the new chunk size (4). The first processing unit may continue processing the chunk of 4 work items, after which the first processing unit may repeat stealing-detection operations and calculate new chunk sizes using either the default equation or the victim equation dependent upon whether other stealing occurred.

In various embodiments, the multi-processor computing device may execute one or more runtime functionalities (e.g., a runtime service, routine, thread, or other software element, etc.) to perform various operations for scheduling or dispatching work items, such as work items for data parallel processing. Such one or more functionalities may be generally referred to herein as a “runtime functionality.” The runtime functionality may be executed by a processing unit of the multi-processor computing device, such as a general purpose or applications processor configured to execute operating systems, services, and/or other system-relevant software. For example, a runtime functionality executing on an application processor may be configured to distribute work items and/or tasks to various processing units and/or calculate chunk sizes for tasks running on one or more processing units.

In some embodiments, the runtime functionality may be a runtime system configured to create tasks (typically by a running thread) and dispatch the tasks to other threads for execution, such as via a task scheduler of the runtime functionality. Such a runtime system may allow concurrency to be achieved when threads are executed on different processing units (e.g., cores). For example, n tasks may be created and dispatched to execute on n available processing units to achieve maximum concurrency.

The following is a non-limiting illustration of an exemplary implementation according to various embodiments. A parallel loop task may be created on a multi-core mobile device (e.g., a four-core device, etc.). The parallel loop task may include 1000 work items (i.e., loop iterations from 0-999). A runtime functionality executing on the applications processor (e.g., a CPU) of the mobile device may create and dispatch tasks for execution via threads on the different cores of the mobile device. Each core (and corresponding task) may be initially assigned a subrange of 250 iterations of the parallel loop by the runtime functionality. The runtime functionality may be configured to continually calculate chunk sizes for each of the cores by using a default equation: chunk_size=int(m/2n), where chunk_size is an integer (e.g., 1 or greater), int( ) is a function returning an integer, n is the number of cores (e.g., 4) and m is the number of iterations assigned to each core (e.g., 250). For example, the initial chunk size (e.g., chunk_size) may be 31 (i.e., 250/(2*4)=31).

For an arbitrary amount of time, the cores may process assigned iterations and periodically perform stealing-detection operations based on the chunk sizes calculated using the default equation. At some first time, a first core (and an associated task) may finish assigned 250 iterations, and thus may become a work-ready processor that is ready to receive “stolen” work items from other cores. At the first time, a second core (and an associated task) may have 100 iterations yet to be processed. The first core may steal part of the second core's 100 iterations for execution based on predefined runtime functionality, and thus the second core becomes a victim processor.

Although now a victim processor, the second core continues executing any remaining iterations in chunks as well as periodically performing stealing-detection operations at the completion of the chunks. Instead of fixing the chunk size for the second core, the runtime functionality may use a victim equation to dynamically adjust the chunk size for the second core. Over time as the execution of the parallel loop task proceeds, the runtime functionality may use either a default equation (e.g., Equation 1A, 1B) or the victim equation (e.g., Equation 2) for calculating subsequent chunk sizes for the second core depending upon whether other stealing occurrences are detected regarding the second core. Unless reassignment operations (i.e., stealing) are detected with relation to the other cores, the runtime functionality may continue to employ the default equation for calculating chunk sizes for the other cores until the parallel loop task is completed.

Methods according to the various embodiments may be performed by the runtime functionality, routines associated with individual processing units of the multi-processor computing device, and any combination thereof. For example, a processing unit may be configured to calculate respective chunk sizes as well as perform operations for detecting whether stealing has occurred. As another example, the runtime functionality may be configured to calculate chunk sizes for various processing units and the processing units may be configured to perform stealing-detection operations at the conclusion of processing of respective chunks.

In various embodiments, chunk sizes for various processing units may or may not be calculated according to the same default or victim frequencies or equations. For example, for a CPU, the multi-processor computing device may calculate default frequency chunk sizes as half of previous chunk sizes, whereas for a GPU, the multi-processor computing device may calculate default frequency chunk sizes as a quarter of previous chunk sizes. Further, due to different operating parameters and/or characteristics of various processing units and/or tasks to be processed, chunk sizes for various processing units may correspond to different periods of time. For example, a CPU may take a first period of time to process a chunk of work items of a particular size (e.g., 10 work items of a cooperative task), whereas a GPU may take a second period of time to process a chunk of the same size.

In various embodiments, default equations for different processing units may be empirically determined. In particular, a chunk size decay rate (e.g., half, quarter, etc.) calculated by a default equation may be based on data of the hardware and/or platform corresponding to the default equation. For example, a default equation used by a GPU may indicate a certain decay rate should be instituted for progressive chunk sizes based on the specifications, manufacturer information, and/or other operating characteristics of the GPU. In some embodiments, the default equations used by various processing units of the multi-processor computing device may be implemented by a concurrency library writer and/or a runtime designer.

In various embodiments, the processing units of the multi-processor computing device may be configured to execute one or more tasks and/or work items associated with a cooperative task (or data parallel processing effort). For example, a GPU may be configured to perform a certain task for processing a set of work items (or iterations) of a parallel loop routine (or workload) also shared by a DSP and a CPU. Methods according to various embodiments may be beneficial in improving data parallel performance in multi-processor computing devices (e.g., heterogeneous SoCs). For example, implementing the stealing-detection operations described, a multi-processor computing device may be capable of speeding up overall execution times for cooperative tasks (e.g., 1.3×-1.8× faster than conventional work-stealing techniques). However, although the embodiment techniques described herein may be used by the multi-processor computing device to improve data parallel processing workloads on a plurality of processing units, other workloads capable of being shared on various processing units may be improved with methods according to the various embodiments.

Determining the frequency for processing units to perform stealing-detection operations may be inherently based on runtime system behaviors, as some equations for calculating chunk sizes depend on the number of work items assigned and completed by individual processing units, which may vary due to the characteristics and operating conditions of the processing units. For at least being aware of multiple processors, the embodiment methods are distinct from conventional time-slicing techniques that merely configure single processor systems to execute various tasks. Further, the methods according to the various embodiments do not address conventional techniques that structure work-stealing within systems, such as by using global queues to dispatch work items. The methods according to various embodiments do not require any particular structure or methodology for implementing work-stealing. Instead, the methods according to various embodiments provide techniques for efficiently detecting the status (or role) of processing units involved in work-stealing scenarios. Thus, the techniques define a number of atomic operations that the individual processing unit may perform consecutively without expending valuable resources to perform such checks. In other words, the methods of various embodiments uniquely provide ways to determine the appropriate frequency (or chunk size) for conducting stealing-detection operations based on runtime behaviors.

The various embodiments are not limited or specific to any type of parallelization system and/or implementation. For example, a homogeneous multi-processor computing device and/or a heterogeneous multi-processor device may be configured to perform operations as described for dynamically adapting the frequency for performing stealing-detection operations. As another example, computing devices that use queues or alternatively shared memory (e.g., a work-stealing data structure, etc.) may benefit from the various embodiments for determining when processing units, tasks, and/or procedures executing on one or more processing units of a multi-processor computing device may perform stealing-detection operations. Therefore, references to any particular type or structure of multi-processor computing device (e.g., heterogeneous multi-processor computing device, etc.) and/or general work-stealing implementation described herein are merely of illustrative purposes and are not intended to limit the scope of embodiments or claims. For example, the various embodiments may be used to determine dynamic chunk sizes used to control when processing units perform stealing-detection operations, but may not affect other aspects of work-stealing algorithms (e.g., calculations to identify a number of work items to reassign to a work-ready processor may be independent of the embodiment techniques for calculating chunk sizes).

Further, the claims and embodiments are not intended to be limited to work-stealing between different processing units of a multi-processor computing device. For example, stealing-detection operations and chunk size calculations of the various embodiments may be performed by one or more processing units, multiple tasks, and/or two or more procedures that are launched by a task-based runtime system and that are configured to potentially steal work items from one another (e.g., steal work items of a shared task). In some embodiments, procedures (e.g., processor-executable instructions for performing operations) may implement various embodiment methods as described. For example, in a thread-based approach, embodiment operations may be performed via procedures that are scheduled on hardware threads and ultimately mapped to processing units (e.g., homogeneous or heterogeneous). As another example, in a task-based approach (e.g., task-based parallelism), embodiment operations may be performed via procedures that are abstracted as tasks and have mappings to hardware threads that are managed by a task-based runtime system.

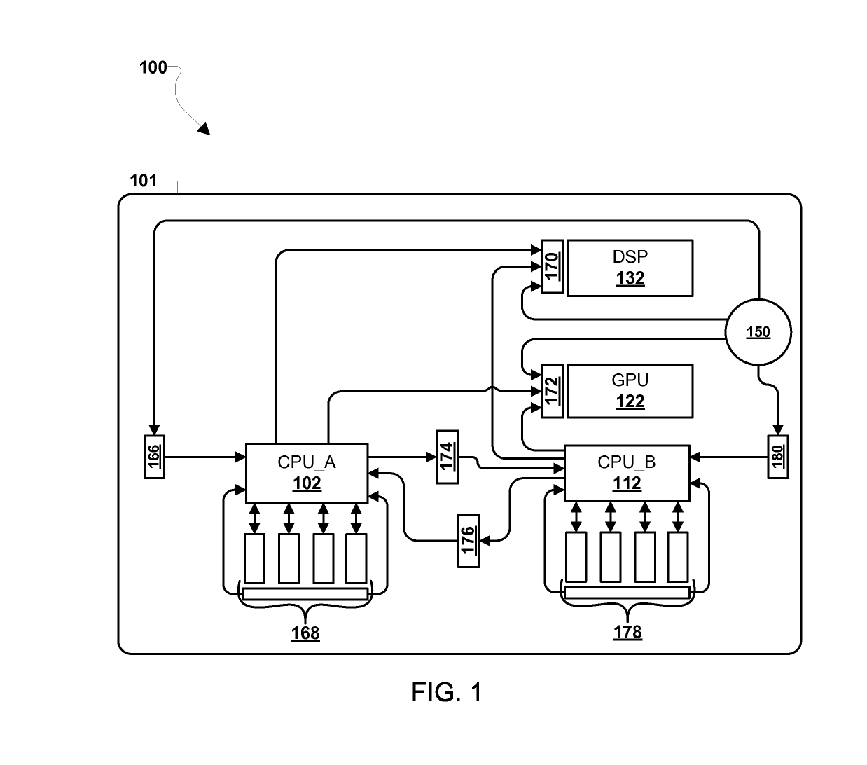

FIG. 1 is a diagram 100 illustrating various components of an exemplary heterogeneous multi-processor computing device 101 suitable for use with various embodiments. The multi-processor computing device 101 may include a plurality of processing units, such as a first CPU 102 (referred to as “CPU_A” 102 in FIG. 1), a second CPU 112 (referred to as “CPU_B” 112 in FIG. 1), a GPU 122, and a DSP 132. In some embodiments, the multi-processor computing device 101 may utilize an “ARM big.Little” architecture, and the first CPU 102 may be a “big” processing unit having relatively high performance capabilities but also relatively high power requirements, and the second CPU 112 may be a “little” processing unit having relatively low performance capabilities but also relatively low power requirements compared to the first CPU 102.

The multi-processor computing device 101 may be configured to support parallel-processing, “work sharing”, and/or “work-stealing” between the various processing units 102, 112, 122, 132. In particular, any combination of the processing units 102, 112, 122, 132 may be configured to create and/or receive discrete tasks for execution.

Each of the processing units 102, 112, 122, 132 may utilize one or more queues (or task queues) for temporarily storing and organizing tasks (and/or data associated with tasks) to be executed by the processing units 102, 112, 122, 132. For example, the first CPU 102 may retrieve tasks and/or task data from task queues 166, 168, 176 for local execution by the first CPU 102 and may place tasks and/or task data in queues 170, 172, 174 for execution by other devices. The second CPU 112 may retrieve tasks and/or task data from task queues 174, 178, 180 for local execution by the second CPU 112 and may place tasks and/or task data in task queues 170, 172, 176 for execution by other devices. The GPU 122 may retrieve tasks and/or task data from the task queue 172. The DSP 132 may retrieve tasks and/or task data from the task queue 170. In some embodiments, some task queues 170, 172, 174, 176 may be so-called multi-producer, multi-consumer queues, and some task queues 166, 168, 178, 180 may be so-called single-producer, multi-consumer queues.

In some embodiments, a runtime functionality (e.g., runtime engine, task scheduler, etc.) may be configured to at least determine destinations for dispatching tasks to the processing units 102, 112, 122, 132. For example, in response to identifying work items of a general-purpose task that may be offloaded to any of the processing units 102, 112, 122, 132, the runtime functionality may identify each processing unit suitable for executing work items and may dispatch the work items accordingly. Such a runtime functionality may be executed on an application processor or main processor, such as the first CPU 102. In some embodiments, the runtime functionality may be performed via one or more operating system-enabled threads (e.g., “main thread” 150). For example, based on determinations of the runtime functionality, the main thread 150 may provide task data to various task queues 166, 170, 172, 180

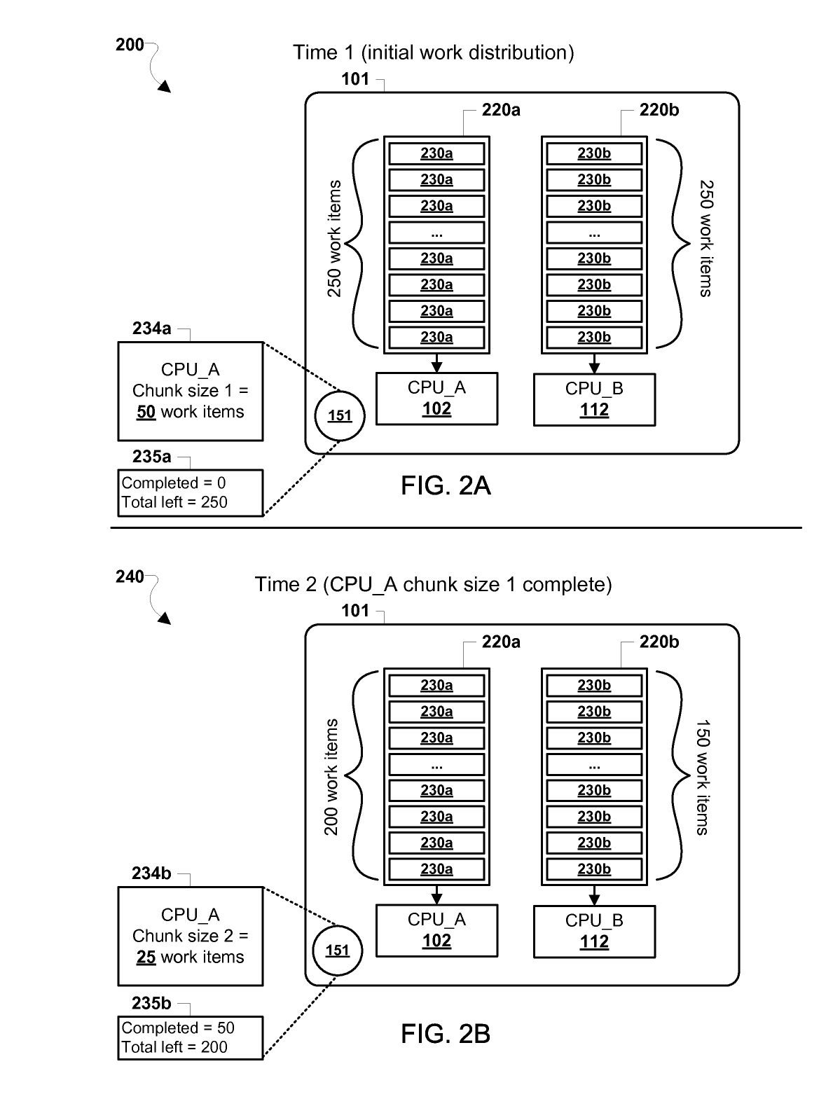

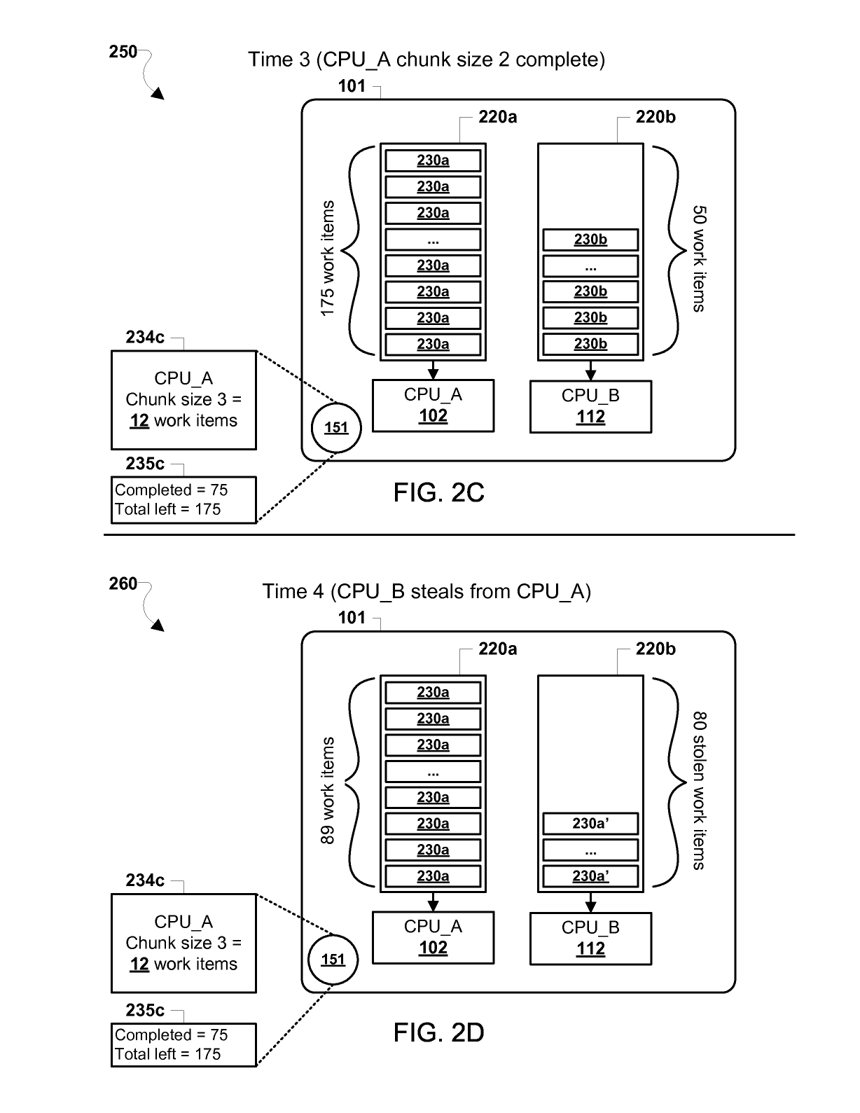

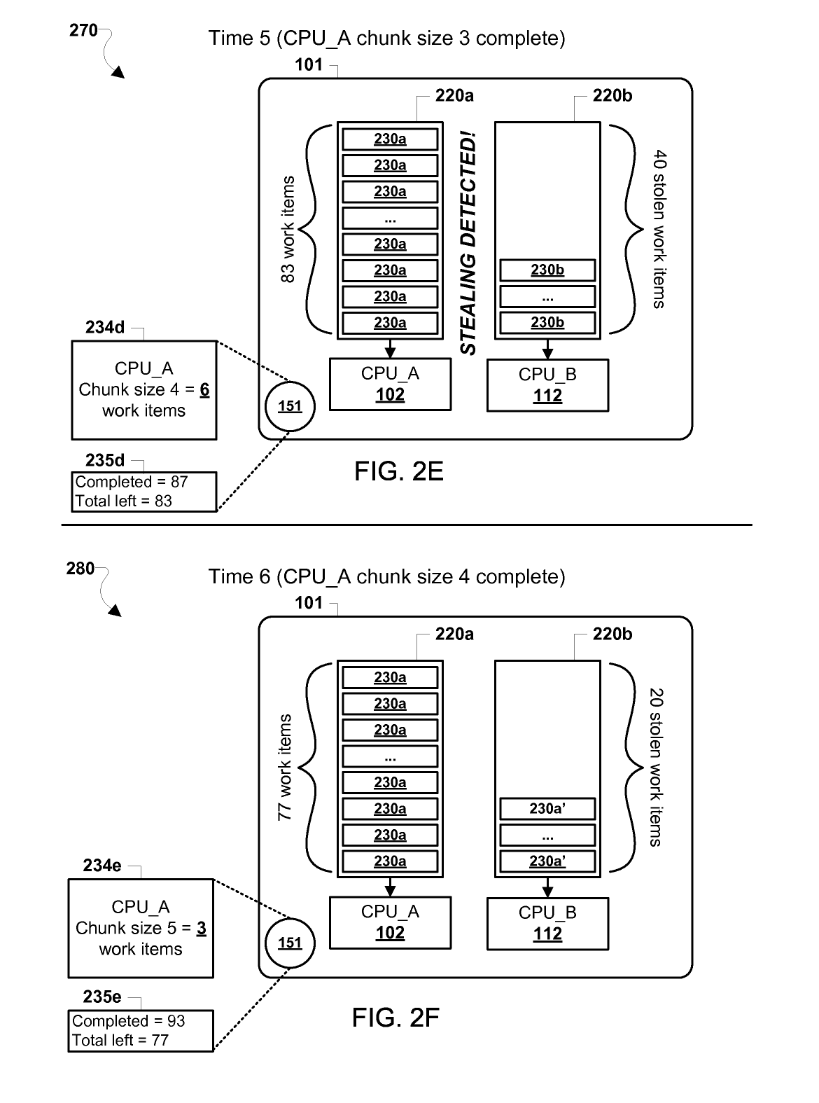

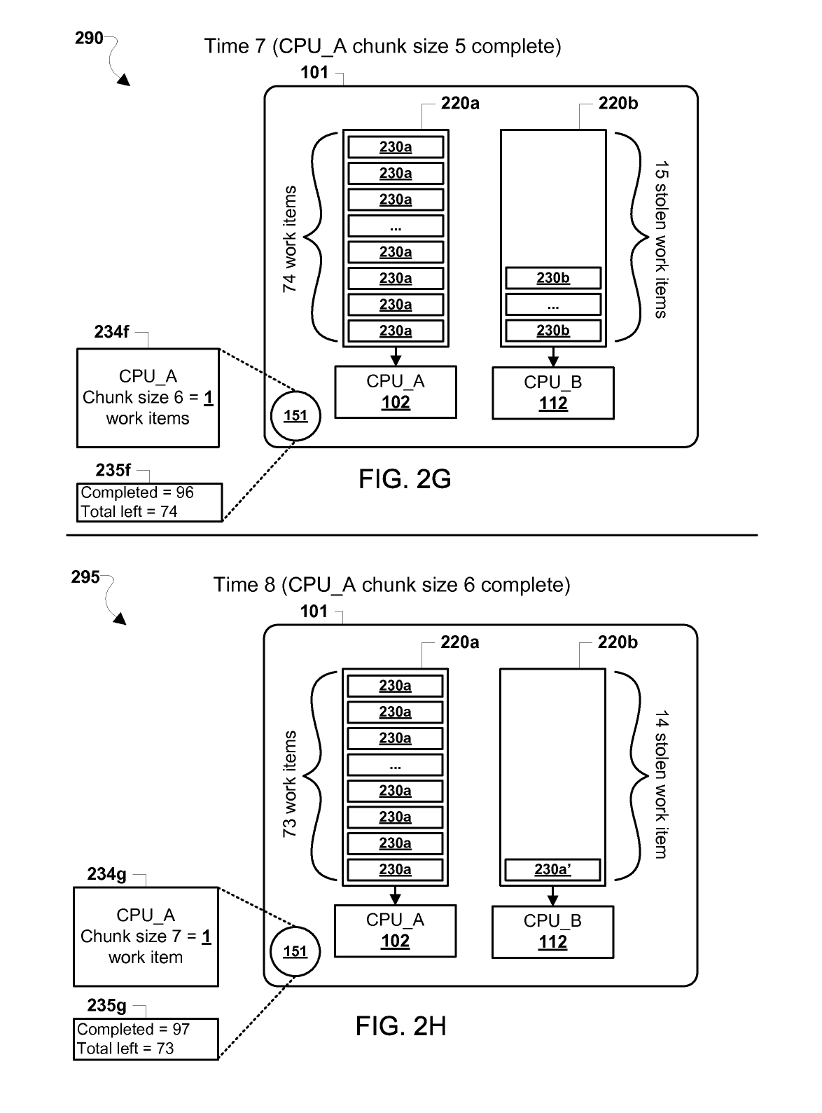

FIGS. 2A-2H illustrate a non-limiting, illustrative scenario in which a multi-processor computing device 101 (e.g., a heterogeneous SoC, etc.) performs stealing-detection operations based on dynamic chunk sizes to improve efficiency of the processing units 102, 112 during such work-stealing opportunities according to various embodiments. The multi-processor computing device 101 may distribute a plurality of work items of a cooperative task (e.g., a parallel loop task, etc.) to a plurality of processing units (e.g., a first CPU 102 and a second CPU 112). Each of the processing units 102, 112 may be associated with a respective task queue 220a, 220b for managing and otherwise storing tasks and/or task data to be processed by the processing units 102, 112. In particular, works items 230a, 230b may be stored within the task queues 220a, 220b. As the processing units 102, 112 may not have the same capabilities and/or operating conditions or parameters (e.g., frequency, etc.), the distributed work items 230a, 230b may be processed at different speeds, thus enabling work-stealing opportunities. In some embodiments, the task queues 220a-220b may be discrete components (e.g., memory units) corresponding to the processing units 102, 112 and/or ranges of memory within various memory units (e.g., system memory, shared memory, virtual memory, etc.).

In some embodiments, work items 230a, 230b may be scheduled and assigned by a scheduler or a runtime functionality 151 executing on a processing unit of the multi-processor computing device 101 (e.g., on an applications processor, etc.). The runtime functionality 151 may also be configured to control the execution of both work-stealing and/or stealing-detection operations in the multi-processor computing device 101, such as by calculating chunk sizes for the processing units 102, 112.

For simplicity, the descriptions of FIGS. 2A-2H only address chunk size calculations for the first CPU 102. For example, FIGS. 2A-2H illustrate that the runtime functionality 151 stores and updates data segments (e.g., data segments 234a, 235a, etc.) corresponding to the first processing unit 102. However, the runtime functionality 151 may be configured to store and/or update data and perform chunk size calculations for any processing units scheduled to perform work items.

Any numeric values included in FIGS. 2A-2H are merely for illustration purposes and are not intended to limit the embodiments or claims in any manner. For example, values indicating particular numbers of work items, chunk sizes, and/or equation values (e.g., coefficients for calculating initial or default chunk sizes, etc.) are provided only to illustrate exemplary implementations of methods according to various embodiments. Additionally, although FIGS. 2A-2H relate to work items 230a, 230b of a cooperative task (e.g., a parallel loop task), methods according to various embodiments may be used to calculate chunk sizes for scheduling stealing-detection operations to be used by processing units executing various types of workloads subject to work-stealing, and thus are not limited to scenarios involving data parallel processing (e.g., cooperative or shared tasks).

FIG. 2A includes a diagram 200 illustrating a first time (e.g., “Time 1”) when work items 230a, 230b of the cooperative task have been distributed to task queues 220a, 220b for processing by the respective processing units 102, 112 of the multi-processor computing device 101. For example, the first task queue 220a associated with the first CPU 102 may initially include 250 work items and the second task queue 220b associated with the second CPU 112 may initially include 250 work items of the cooperative task (e.g., a parallel loop task). As the work items 230a, 230b have just been distributed (i.e., the cooperative task has only just been initiated), no stealing has yet occurred between the processing units 102, 112.

At the first time, the runtime functionality 151 may calculate initial or default chunk sizes that indicate when each processing unit 102, 112 may perform first stealing-detection operations (i.e., calculate an initial frequency for checking for the occurrence of stealing). In some embodiments, the initial chunk size may be a predefined number of work items and/or a predefined fraction of the total work items assigned to a processing unit. For example, the initial chunk size for the first processing unit 102 may be calculated as a fifth of the total number of work items 230a assigned to the first processing unit 102 (i.e., 250 total work items/5=50 work item chunk size).

In some embodiments, the initial chunk size for a processing unit may be based on an estimation of the time until a first reassignment operation (i.e., stealing) occurs regarding that processing unit. The following is an example of estimating initial chunk sizes. The runtime functionality 151 may launch n procedures (e.g., on one or more processing units) in which there is a non-negligible latency between launch time of the n procedures. Each of the n procedures may be initially assigned the same number of work items. A first procedure may be expected to complete an assigned workload first. Accordingly, an initial chunk size for the first procedure may be estimated as the average number of work items the other n procedures may complete by the time the first procedure completes all respective assigned work items.

In some cases, there may be differences in initial chunk sizes of various procedures due to latency between the runtime functionality 151 successively launching the procedures. For example, at a first time, a first procedure may be launched to work on assigned work items (e.g., 100 work items). At a second time (e.g., 1 second after the first time), a second procedure may be launched to work on assigned work items (e.g., 100 work items). In between the first and second times, the first procedure may have finished processing a number of respective assigned work items (e.g., 50 work items). So, by the time the second procedure finishes the same number of work items (e.g., 50 items), the first procedure may have become ready to steal work items. Thus, the initial chunk size for the first procedure may be set to 50 accordingly.

In some embodiments, the runtime functionality 151 may store and track data indicating the current chunk sizes and other progress information for the processing units 102, 112 with regard to participation in the cooperative task. For example, the runtime functionality 151 may store a chunk size data segment 234a that indicates a current chunk size (e.g. 50 work items) for the first processing unit 102. The runtime functionality 151 may also store a status data segment 235a that indicates the number of completed work items (e.g., 0 initially) and remaining work items (e.g., 250 initially) for the first processing unit 102. Such stored data may be used by the runtime functionality 151 to calculate subsequent chunk sizes for the processing unit 102 as described.

FIG. 2B includes a diagram 240 illustrating a second time (e.g., “Time 2”) corresponding to the completion of a workload of the initial chunk size (e.g., 50 work items) for the first processing unit 102. In other words, the second time may occur when the first processing unit 102 has completed processing the 50 work items 230a defined by the initial chunk size as stored in the chunk size data segment 234a. There may still be work items 230a, 230b in both task queues 220a, 220b of the processing units 102, 112 at the second time. For example, the first task queue 220a may still have 200 work items 230a (i.e., 250 initial work items−50 work items corresponding to the initial chunk size). However, due to a faster processing rate, the second processing unit 112 may only have 150 work items 230b remaining in the respective task queue 220b at the second time.

At the second time, the first processing unit 102 may perform stealing-detection operations to detect whether any of the work items 230a have been reassigned to the second processing unit 112 in between the first time of FIG. 2A and the second time. For example, the first processing unit 102 (or alternatively the runtime functionality 151) may evaluate a stealing bit, flag, or other stored data to determine whether the second processing unit 112 has been assigned one or more of the work items 230a originally distributed to the first task queue 220a. At the second time, the first processing unit 102 may determine that no stealing occurred as both processing units 102, 112 are still processing the originally-distributed workloads.

In some embodiments, the stealing-detection operations may be performed by checking a primitive data structure shared by various processing units (and/or tasks). Such a data structure may be a shared work-stealing data structure. For example, the work-stealing data structure may include data (e.g., an index) representing the next-to-process work item. Work-ready processors may write a pre-defined value to such an index to make that index invalid, thus indicating that the remaining range of work items has been stolen. Victim processors may detect that stealing has occurred based on a check of the index. The rest of the work items may be re-assigned based on an agreement defined in runtime. Writing to the index and checking the index may be implemented using locks or hardware-specific atomic operations.

The runtime functionality 151 may update stored data segments 234b, 235b associated with the first processing unit 102 based on the processing on the work items 230a since the first time illustrated in FIG. 2A. For example, the runtime functionality 151 may update the status data segment 235b to indicate 50 work items have been completed and 200 work items are remaining for the first processing unit 102. The runtime functionality 151 may also update the stored chunk size data segment 234b to define the next opportunity that the first processing unit 102 may perform stealing-detection operations. For example, the runtime functionality 151 may use a default equation to calculate an updated, second chunk size as a fraction of the initial chunk size, such as by dividing the initial chunk size of 50 work items by 2 (i.e., halving the previous chunk size) to calculate the second chunk size of 25 work items. In some embodiments, the runtime functionality 151 may use various default equations or calculations for updating (or reducing) the chunk size prior to detecting stealing, such as by reducing the previous chunk size by a preset amount (e.g., by a set number of work items until the chunk size is 1 work item), by a percentage of the originally-distributed workload, or by a percentage of the remaining workload (e.g., a half, a third, a fourth, etc.).

FIG. 2C includes a diagram 250 illustrating a third time (e.g., “Time 3”) corresponding to the completion of a chunk of the second chunk size (e.g., 25 work items) by the first processing unit 102. The third time may occur when the first processing unit 102 has completed processing the chunk of 25 work items 230a corresponding to the second chunk size stored in the chunk size data segment 234b. There may still be work items 230a, 230b in both task queues 220a, 220b of the processing units 102, 112 at the third time. For example, the first task queue 220a may still have 175 work items 230a (i.e., 200 work items at the second time−25 work items of the latest chunk). The second processing unit 112 may only have 50 work items 230b remaining in the respective task queue 220b at the third time.

At the third time, the first processing unit 102 may perform stealing-detection operations to detect whether any of the work items 230a have been reassigned to the second processing unit 112 in between the second time of FIG. 2B and the third time. For example, the first processing unit 102 (or alternatively the runtime functionality 151) may evaluate a stealing bit, flag, or other stored data to determine whether the second processing unit 112 has been assigned one or more of the work items 230a originally distributed to the first task queue 220a. At the third time, the first processing unit 102 may determine that no stealing occurred as both processing units 102, 112 are still processing the originally-distributed workloads.

The runtime functionality 151 may update stored data segments 234c, 235c associated with the first processing unit 102 based on the processing of the work items 230a since the second time illustrated in FIG. 2B. For example, the runtime functionality 151 may update the status data segment 235c to indicate 75 work items have been completed and 175 work items are remaining for the first processing unit 102. The runtime functionality 151 may also update the stored chunk size data segment 234c to define the next opportunity that the first processing unit 102 may perform stealing-detection operations. For example, the runtime functionality 151 may use the default equation to calculate a third chunk size as 12 work items (e.g., the floor integer of half of the second chunk size of 25).

Due to the operating characteristics of the second processing unit 112 and/or the work items 230b, the second processing unit 112 may eventually complete respective workloads and thus become available to be assigned work items from other processing units. FIG. 2D includes a diagram 260 illustrating a fourth time (e.g., “Time 4”) corresponding to a reassignment operation (i.e., stealing) wherein the second processing unit 112 is assigned work items 230a′ (e.g., 80 work items) that were originally distributed for processing by the first processing unit 102. At the fourth time, the second processing unit 112 may have completed all of the work items 230b originally distributed to the second task queue 220b, making the second processing unit 112 eligible to receive work items from other processing units. In other words, at the fourth time the second processing unit 112 may be considered a “work-ready processor” with regard to the cooperative task.

At the fourth time, the first processing unit 102 may not have completed all of a current chunk (e.g., 12 work items) since the third time, and thus no stealing-detection operations may be performed by the first processing unit 102 at the fourth time. Regardless, the first processing unit 102 may have processed a number of work items 230a since the third time (e.g., 6 work items), making the remaining work items count 169 prior to any stealing and the total completed work items count 81. In response to the second processing unit 112 being ready to receive other work for the cooperative task at the fourth time, the runtime functionality 151 may reassign work items 230a from the first task queue 220a to the second task queue 220b associated with the second processing unit 112. For example, the runtime functionality 151 may move 80 work items 230a′ from the first task queue 220a to the second task queue 220b, leaving the first task queue 220a with 89 total remaining work items 230a at the fourth time. As a result of the reassignment operation, the first processing unit 102 may be considered a “victim processor” with regard to the cooperative task at the fourth time. In some embodiments, the runtime functionality 151 may set a stealing bit, flag, or other stored data to identify that work items 230a have been reassigned away from the first processing unit 102. In some embodiments, the second processing unit 112 may acquire ownership over a lock and adjust data within a work-stealing data structure at the fourth time in order to indicate a stealing has occurred and/or cause work items to be reassigned.

Reassignment operations (i.e., stealing) may cause the runtime functionality 151 to use particular victim equations to calculate the chunk sizes for victim processors. As described, a victim equation may be used to calculate chunk sizes based on various data indicating the progress of a processing unit with regard to assigned work items (e.g., a number of work items completed before a stealing operation, a number of work items remaining after the stealing operation, etc.). In some embodiments, to provide data for use with such a victim equation, the runtime functionality 151 may be configured to track or otherwise store status data at the time of the reassignment to use in subsequent chunk size calculations for the victim processor. For example, the runtime functionality 151 may store data indicating the number of work items that are completed and/or remaining to be completed at a stealing occurrence.

FIG. 2E includes a diagram 270 illustrating a fifth time (e.g., “Time 5”) corresponding to the completion of a chunk of the third chunk size (e.g., 12 work items) by the first processing unit 102. Regardless of the reassignment operation at the fourth time, the fifth time may occur when the first processing unit 102 has completed processing the chunk of 12 work items 230a defined by the third chunk size stored in the chunk size data segment 234c. At the fifth time, the first task queue 220a may include originally-assigned work items 230a and the second task queue 220b may include reassigned work items 230a′. For example, the first task queue 220a may include 83 work items 230a and the second task queue 220b may include 40 stolen or reassigned work items 230a′.

At the fifth time, the first processing unit 102 may perform stealing-detection operations to detect whether any of the work items 230a have been re-assigned to the second processing unit 112 in between the third time of FIG. 2C and the fifth time of FIG. 2E. For example, the first processing unit 102 (or alternatively the runtime functionality 151) may evaluate a stealing bit, flag, or other stored data to determine whether the second processing unit 112 has been assigned one or more of the work items 230a originally distributed to the first task queue 220a. As another example, the first processing unit 102 may evaluate data (e.g., an index) stored in a shared data structure to determine whether stealing has occurred regarding work items originally-assigned to the first processing unit 102. Based on the reassignment operations at the fourth time, the first processing unit 102 may detect stealing has occurred and thus the first processing unit 102 is a victim processor.

The runtime functionality 151 may update stored data segments 234d, 235d associated with the first processing unit 102. For example, the runtime functionality 151 may update the status data segment 235d to indicate 87 work items have been completed and 83 work items are remaining for the first processing unit 102. However, unlike in previous calculations of the chunk size for the first processing unit 102, the runtime functionality 151 may utilize a victim equation for calculating chunk sizes as the first processing unit 102 has been identified as a victim processor at the fifth time. For example, the runtime functionality 151 may utilize Equation 2 as described to calculate the fourth chunk size as follows:

$${T}^{′} = int ( \frac{q}{p} * T ) = int ( \frac{83}{175} * 12 ) = 6 ( rounded \text{-} up from 5.69 )$$

where T′ is the new chunk size, T is the previously-calculated chunk size (e.g., the value of 12 from the chunk size data segment 234c stored at the third time), p is the total number of remaining work items to be processed before the stealing happens from the status data segment 235c stored at the third time (p=175), and q is the number of remaining work items after the stealing occurred from the status data segment 235d stored at the fifth time (q=83). The calculated new chunk size may be stored in the chunk size data segment 234d (e.g., 6 work items).

FIG. 2F includes a diagram 280 illustrating a sixth time (e.g., “Time 6”) in which the first processing unit 102 may have processed a chunk corresponding to the chunk size calculated at the fifth time (e.g., 6 work items). The second processing unit 112 may still be processing the previously reassigned work items 230a′ at the sixth time (e.g., 20 stolen work items remaining). Thus, the first processing unit 102 may perform stealing-detection operations and determine that no stealing occurred in between the fifth and sixth times.

The runtime functionality 151 may update stored data segments 234e, 235e associated with the first processing unit 102 based on the processing of the work items 230a since the fifth time illustrated in FIG. 2E. For example, the runtime functionality 151 may update the status data segment 235e to indicate 93 work items have been completed and 77 work items are remaining for the first processing unit 102. The runtime functionality 151 may also update the stored chunk size data segment 234e to define the next opportunity that the first processing unit 102 may perform stealing-detection operations. For example, the runtime functionality 151 may use the default equation to calculate a fifth chunk size as 3 work items (e.g., the floor integer of half of the fourth chunk size of 6).

FIG. 2G includes a diagram 290 illustrating a seventh time (e.g., “Time 7”) corresponding to the completion of a chunk of the fifth chunk size (e.g., 3 work items) by the first processing unit 102. At the seventh time, the first task queue 220a may include originally-assigned work items 230a and the second task queue 220b may include reassigned work items 230a′. For example, the first task queue 220a may include 74 work items 230a and the second task queue 220b may include 15 stolen or reassigned work items 230a′. The first processing unit 102 may again perform stealing-detection operations at the seventh time. The runtime functionality 151 may update stored data segments 234f, 235f associated with the first processing unit 102. For example, the runtime functionality 151 may update the status data segment 235f to indicate 96 work items have been completed and 74 work items are remaining for the first processing unit 102. Since there was no stealing in between the sixth and seventh times, the runtime functionality 151 may utilize the default equation to calculate a sixth chunk size (e.g., 1 work item) using the default equation. The sixth chunk size may be stored in the chunk size data segment 234f. At 1 work item, the sixth chunk size may be the lowest chunk size (or lowest bound) the runtime functionality 151 may be configured to calculate, and thus any subsequent chunk sizes for the first processing unit 102 may likewise be set at 1 work item, as shown in FIG. 2H.

FIG. 2H includes a diagram 295 illustrating an eighth time (e.g., “Time 8”) corresponding to the completion of a chunk of the sixth chunk size (e.g., 1 work items) by the first processing unit 102. At the eighth time, the first task queue 220a may include originally-assigned work items 230a and the second task queue 220b may include reassigned work items 230a′. For example, the first task queue 220a may include 73 work items 230a and the second task queue 220b may include 14 stolen work items 230a′. The first processing unit 102 may again perform stealing-detection operations at the eighth time. The runtime functionality 151 may update stored data segments 234g, 235g associated with the first processing unit 102. For example, the runtime functionality 151 may update the status data segment 235g to indicate 97 work items have been completed and 73 work items are remaining for the first processing unit 102. Since there was no stealing in between the seventh and eighth times, the runtime functionality 151 may utilize the default equation to calculate a seventh chunk size (e.g., 1 work item) that is stored in the chunk size data segment 234g.

The reassignment operations may continue until all work items 230a of the cooperative task are processed by the processing units 102, 112. At the completion of the cooperative task, the various data segments (e.g., chunk size and status data segments) stored for various processing units may be reset, cleared, or otherwise returned to an initial state for use in other tasks that involve work-stealing and/or stealing-detection operations according to various embodiments.

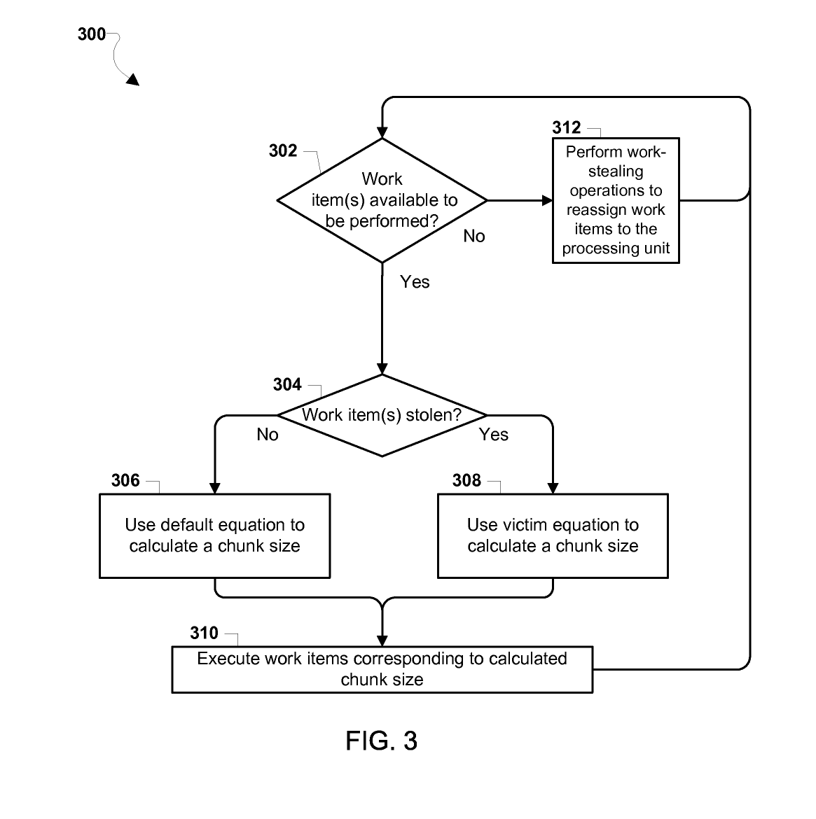

FIG. 3 illustrates a method 300 performed by a multi-processor computing device to calculate chunk sizes that define a frequency for performing stealing-detection operations for a processing unit according to various embodiments. As described, the multi-processor computing device (e.g., multi-processor computing device 101) may be configured to perform various tasks using one or more processing units. For example, cooperative tasks (e.g., parallel loops, etc.) may be executed by distributing associated sets of work items for concurrent execution on a plurality of processing units. As the different processing units of the multi-processor computing device may have different speeds, throughputs, and/or other capabilities or operating conditions, work items may be processed at different rates on the different processing units, allowing for work-stealing to occur. For example, if a GPU completes assigned work items of a shared task before a DSP can complete respective work items, the GPU may be assigned a portion of the DSP's work items. The multi-processor computing device may employ the method 300 to ensure that chunk sizes used by the processing units are dynamically adjusted in order to balance the frequency of checking for stealing and performing assigned work items.

In various embodiments, the method 300 may be performed for each processing unit within the multi-processor computing device. For example, the multi-processor computing device may concurrently execute one or more instances of the method 300 (e.g., one or more threads for executing method 300) to handle the execution of work items on various processing units. In some embodiments, various operations of the method 300 may be performed by a runtime functionality (e.g., a runtime scheduler, main thread 150) executing via a processing unit of a multi-processor computing device, such as the first CPU 102 of the multi-processor computing device 101. In some embodiments, operations of the method 300 may be performed by individual processing units and/or associated routines.

In determination block 302, a processor of the multi-processor computing device may determine whether there are any work items of a cooperative task that are available to be performed by a processing unit. For example, the multi-processor computing device may evaluate a task queue associated with the processing unit to determine whether any work items are pending to be executed. In response to determining that there are no work items of the cooperative task that are available to be performed by the processing unit (i.e., determination block 302=“No”), the processor may perform work-stealing operations that assign one or more work items that were originally-assigned to other processing units to the processing unit in block 312. The processor may then continue determining whether there are any work items of a cooperative task that are available to be performed by the processing unit in determination block 302.

In some embodiments, in response to determining that there are no work items of the cooperative task that are available to be performed by the processing unit (i.e., determination block 302=“No”), the multi-processor computing device may simply end the method 300. In some embodiments, the reassignment (or stealing) of work items may include data transfers between queues and/or assignments of access to particular data, such as via a check-out or assignment procedure for a shared memory unit. For example, the processor may adjust data in a shared work-stealing data structure to indicate that work items in a shared memory that were previously assigned to a victim processor are now assigned to the processor. As another example, the processor may acquire ownership over a lock to a shared work-stealing data structure and then may write to an index to indicate that a remaining range of work items has been stolen.

In response to determining that there are work items of the cooperative task that are available to be performed by the processing unit (i.e., determination block 302=“Yes”), the processor may determine whether any work items have been “stolen” from the processing unit in determination block 304. In particular, the processor may perform stealing-detection operations to determine whether any tasks or task data (i.e., work items) that were originally assigned to the processing unit have been removed from the task queue of the processing unit and reassigned to one or more other processing units. In various embodiments, the determination may relate to the occurrence of stealing related to the processing unit over the course of processing the previous chunk of work items. For example, the processor may determine whether any re-assignment of originally-assigned work items to other processing units occurred while the processing unit was processing a set of work items having a size calculated via various equations (e.g., Equation 1A, Equation 1B, Equation 2, etc.). The determination of whether work items have been stolen from the processing unit by other processing units may not be directly based on whether the processing unit was previously identified as a victim processor for the current cooperative task or any other task. For example, in a first iteration of the method 300, the processor may determine that the processing unit has not been stolen from; in a second iteration of the method 300 occurring after the processing unit processes a first chunk, the processor may determine that the processing unit was stolen from while processing the first chunk; and in a third iteration of the method 300 occurring after the processing unit processes a second chunk, the processor may determine that the processing unit was not stolen from while processing the second chunk.

In some embodiments, the determination may be made by evaluating a system variable, bit, flag, and/or other data associated with the processing unit that may be updated in response to work-stealing operations. For example, in response to a runtime functionality determining that a work item from the processing unit's task queue may be reassigned to a work-ready processor having no work items, the runtime functionality may set a bit associated with the processing unit indicating that the work item was stolen from the processing unit. In some embodiments, data associated with the processing unit that indicates whether work items have been stolen may be reset or otherwise cleared by the multi-processor computing device due to various conditions. For example, data for the processing unit may be cleared to indicate no work items have been stolen by other processing units in response to the runtime functionality detecting that all work items of a parallel processing task have been completed.

In some embodiments, stealing-detection operations may include the processor checking a primitive data structure shared by various processing units (and/or tasks) (e.g., a shared work-stealing data structure). For example, the processor may determine whether the processing unit is a victim processor at a given time (or during a given chunk) by checking data in a shared data structure (e.g., an index with a value that indicates whether a work-ready processor has been re-assigned one or more work items).

In response to determining that no work items have been stolen from the task queue of the processing unit (i.e., determination block 304=“No”), the processor may use a default equation to calculate a chunk size in block 306. As described, the chunk size may indicate a number of work items to be processed by the processing unit. The chunk size may define the interval of time (or frequency) in between performing stealing-detection operations for the processing unit. For example, a chunk size representing a certain number of work items may define an amount of time required for the processing unit to process that number of work items (or chunk).

The default equation may be an equation or formula (e.g., Equation 1A, Equation 1B) used in block 306 to calculate chunk sizes that decrease over time at a default rate or frequency. For example, if no stealing has been detected in between calculating chunk sizes (e.g., no stealing occurred during the processing of a previous chunk of work items), the processor may calculate chunk sizes for the processor unit by continually halving the previously-calculated chunk size. The default equation may be used to iteratively reduce the chunk size in between each stealing-detection operation for the processing unit until the chunk size is calculated as a floor or lower bound value. For example, the chunk size may be continually reduced until the chunk size is a value of 1 (e.g., 1 work item). As another example, such a default equation used in block 306 may be represented by the following equation:

$${T}^{′} = int ( \frac{T}{x} ) ,$$

where T′ represents a new chunk size, int( ) represents a function that returns an integer value (e.g., floor( ), ceiling( ), round( ), etc.), T represents the previously calculated chunk size, and x represents a non-zero float or integer value (e.g., 2, 3, 4, etc.) greater than 1.

In some embodiments, the default equation used in block 306 may be linear or non-linear. In some embodiments, the default equation may be different for various processing units of the multi-processor computing device. For example, a CPU may calculate subsequent chunk sizes as half of previous chunk sizes (e.g., using a first default equation), whereas a GPU may calculate subsequent chunk sizes as a quarter of previous chunk sizes (e.g., using a second default equation).

In response to determining that one or more work items have been stolen from the task queue of the processing unit (i.e., determination block 304=“Yes”), the processor may identify the processing unit as a “victim processor,” and use a victim equation (e.g., Equation 2) to calculate a chunk size in block 308. As described, when a processing unit is identified as a victim processor (i.e., another processing unit has been assigned one or more work items from the task queue of the processing unit), the chunk size may be calculated differently than may be calculated using a default manner. In other words, the victim equation may be used to calculate different (e.g., smaller in size, more rapidly reducing, etc.) chunk sizes than those previously calculated using the default equation described.

In some embodiments, the victim equation that may be used in block 308 to calculate chunk sizes may reflect the complete progress of the processing unit for a cooperative task. For example, the victim equation (Equation 2) may be as follows:

$${T}^{′} = int ( \frac{q}{p} * T )$$

where T′ may represent a current (or new) chunk size, int( ) may represent a function that returns an integer value (e.g., floor( ), ceiling( ), round( ), etc.), T may represent a previously-calculated chunk size, p may represent the total number of remaining work items (or iterations) to be processed before stealing happens, and q may represent the remaining work items (or iterations) after stealing happens (i.e., after a reassignment). In various embodiments, the victim equation may calculate chunk sizes that are continually reduced until the chunk size is a value of 1 (e.g., 1 work item).

In response to calculating the chunk size with either the default equation in block 306 or the victim equation in block 308, the processing unit may execute work items corresponding to the calculated chunk size in block 310. For example, the processing unit may process a number of work items of a parallel processing task according to the calculated chunk size. The time to complete the chunk of work items corresponding to the calculated chunk size may differ between the processing units of the multi-processor computing device. For example, a first CPU may process a certain number of work items (e.g., n iterations of a parallel loop, etc.) in a first time, whereas due to different capabilities (e.g., frequency, age, temperature, etc.), a second CPU may process that same number of work items in a second time (e.g., a shorter time, a longer time, etc.).

Once the work items corresponding to the chunk size are executed, the processor may repeat the operations of the method 300 by again determining whether there are any work items of a cooperative task that are available to be performed by a processing unit in determination block 302. The operations of the method 300 may be continually performed until there are no more work items remaining to be executed for the cooperative task.

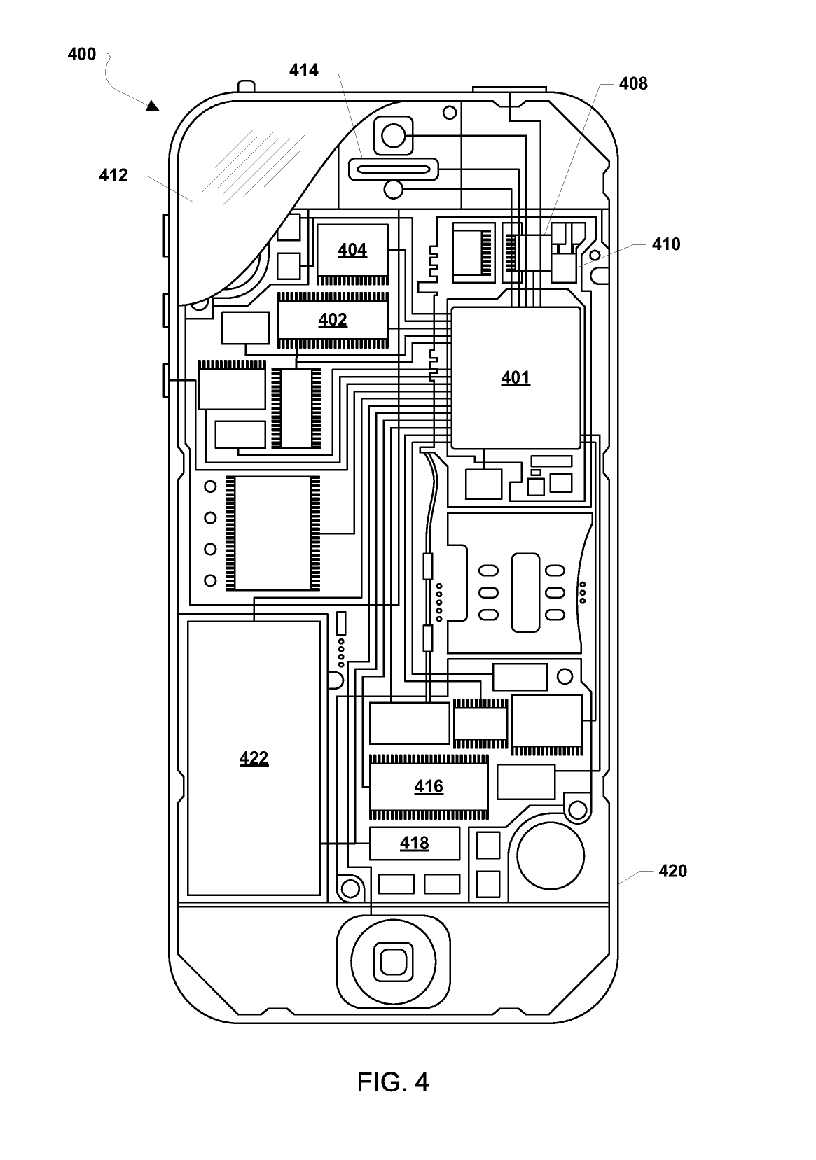

Various forms of multi-processor computing devices, including personal computers, mobile devices, and laptop computers, may be used to implement the various embodiments. Such computing devices may typically include the components illustrated in FIG. 4 which illustrates an example multi-processor mobile device 400. In various embodiments, the mobile device 400 may include a processor 401 coupled to a touch screen controller 404 and an internal memory 402. The processor 401 may include a plurality of multi-core ICs designated for general and/or specific processing tasks. In some embodiments, other processing units may also be included and coupled to the processor 401 (e.g., GPU, DSP, etc.).

The internal memory 402 may be volatile and/or non-volatile memory, and may also be secure and/or encrypted memory, or unsecure and/or unencrypted memory, or any combination thereof. The touch screen controller 404 and the processor 401 may also be coupled to a touch screen panel 412, such as a resistive-sensing touch screen, capacitive-sensing touch screen, infrared sensing touch screen, etc. The mobile device 400 may have one or more radio signal transceivers 408 (e.g., Bluetooth®, ZigBee®, Wi-Fi®, radio frequency (RF) radio, etc.) and antennae 410, for sending and receiving, coupled to each other and/or to the processor 401. The transceivers 408 and antennae 410 may be used with the above-mentioned circuitry to implement the various wireless transmission protocol stacks and interfaces. The mobile device 400 may include a cellular network wireless modem chip 416 that enables communication via a cellular network and is coupled to the processor 401. The mobile device 400 may include a peripheral device connection interface 418 coupled to the processor 401. The peripheral device connection interface 418 may be singularly configured to accept one type of connection, or multiply configured to accept various types of physical and communication connections, common or proprietary, such as universal serial bus (USB), FireWire, Thunderbolt, or PCIe. The peripheral device connection interface 418 may also be coupled to a similarly configured peripheral device connection port (not shown). The mobile device 400 may also include speakers 414 for providing audio outputs. The mobile device 400 may also include a housing 420, constructed of a plastic, metal, or a combination of materials, for containing all or some of the components discussed herein. The mobile device 400 may include a power source 422 coupled to the processor 401, such as a disposable or rechargeable battery. The rechargeable battery may also be coupled to the peripheral device connection port to receive a charging current from a source external to the mobile device 400.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The various processors described herein may be any programmable microprocessor, microcomputer or multiple processor chip or chips that can be configured by software instructions (applications) to perform a variety of functions, including the functions of the various embodiments described herein. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor-readable, computer-readable, or server-readable medium or a non-transitory processor-readable storage medium. The operations of a method or algorithm disclosed herein may be embodied in a processor-executable software module or processor-executable software instructions which may reside on a non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the embodiment techniques of the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

1. A method for dynamically adapting a frequency for detecting work-stealing occurrences in a multi-processor computing device, comprising:
determining, via a processor of the multi-processor computing device, whether any work items of a cooperative task have been reassigned from a first processing unit to a second processing unit;
calculating, via the processor, a chunk size using:
a victim equation in response to determining that one or more work items of the cooperative task have been reassigned from the first processing unit to the second processing unit; and
executing, via the processor, a set of work items of the cooperative task that correspond to the calculated chunk size.

2. The method of claim 1, wherein calculating, via the processor, a chunk size, further comprises using:
a default equation in response to determining that no work items of the cooperative task have been reassigned from the first processing unit to the second processing unit;
wherein the default equation is:
$${T}^{′} = \frac{T}{x} ,$$
wherein T′ represents the chunk size, T represents a previously calculated chunk size, and x is a non-zero value.

3. The method of claim 1, wherein calculating, via the processor, a chunk size, further comprises using:
a default equation in response to determining that no work items of the cooperative task have been reassigned from the first processing unit to the second processing unit;
wherein the default equation is:
$${T}^{′} = \frac{m}{( x * {2}^{n} )} ,$$
wherein T′ represents the chunk size, m represents a total number of work items assigned to the first processing unit, x is a non-zero value, and n is a counter representing a number of times the chunk size has been calculated for the first processing unit for the cooperative task.

4. The method of claim 3, wherein n represents a total number of processing units executing work items of the cooperative task.

5. The method of claim 1, wherein the victim equation is:
$${T}^{′} = int ( \frac{q}{p} * T ) ,$$
wherein T′ represents a new chunk size, int( ) represents a function that returns an integer value, T represents a previously-calculated chunk size, p represents a total number of remaining work items to be processed before a reassignment operation occurs, and q represents a number of remaining work items after the reassignment operation.

6. The method of claim 1, wherein the cooperative task is a parallel loop task.

7. The method of claim 1, wherein the multi-processor computing device is a heterogeneous multi-processor computing device that includes two or more of a first central processing unit (CPU), a second central processing unit (CPU), a graphics processing unit (GPU), and a digital signal processor (DSP).

8. The method of claim 1, wherein the first processing unit and the second processing unit are the same processing unit that is executing two or more procedures that are each assigned different work items of the cooperative task.

9. A computing device, comprising:
a memory; and
a processor of a plurality of processing units, wherein the processor is coupled to the memory and configured with processor-executable instructions to perform operations comprising:
determining whether any work items of a cooperative task have been reassigned from a first processing unit to a second processing unit;
calculating a chunk size using a victim equation in response to determining that one or more work items of the cooperative task have been reassigned from the first processing unit to the second processing unit; and
executing a set of work items of the cooperative task that correspond to the calculated chunk size.

10. The computing device of claim 9, wherein the processor is further configured with processor-executable instructions to perform operations comprising:
calculating the chunk size using a default equation in response to determining that no work items of the cooperative task have been reassigned from the first processing unit to the second processing unit;
wherein the default equation is:
$${T}^{′} = \frac{T}{x} ,$$
wherein T′ represents the chunk size, T represents a previously calculated chunk size, and x is a non-zero value.

11. The computing device of claim 9, wherein the processor is further configured with processor-executable instructions to perform operations comprising:
calculating the chunk size using a default equation in response to determining that no work items of the cooperative task have been reassigned from the first processing unit to the second processing unit;
wherein the default equation is:
$${T}^{′} = \frac{m}{( x * {2}^{n} )} ,$$
wherein T′ represents the chunk size, m represents a total number of work items assigned to the first processing unit, x is a non-zero value, and n is a counter representing a number of times the chunk size has been calculated for the first processing unit for the cooperative task.

12. The computing device of claim 11, wherein n represents a total number of processing units executing work items of the cooperative task.

13. The computing device of claim 9, wherein the victim equation is:
$${T}^{′} = int ( \frac{q}{p} * T ) ,$$
wherein T′ represents a new chunk size, int( ) represents a function that returns an integer value, T represents a previously-calculated chunk size, p represents a total number of remaining work items to be processed before a reassignment operation occurs, and q represents a number of remaining work items after the reassignment operation.

14. The computing device of claim 9, wherein the cooperative task is a parallel loop task.

15. The computing device of claim 9, wherein the plurality of processing units includes two or more of a first central processing unit (CPU), a second central processing unit (CPU), a graphics processing unit (GPU), and a digital signal processor (DSP).

16. The computing device of claim 9, wherein the first processing unit and the second processing unit are the same processing unit that is executing two or more procedures that are each assigned different work items of the cooperative task.

17. A non-transitory processor-readable storage medium having stored thereon processor-executable instructions configured to cause a processor of a computing device to perform operations comprising:
determining whether any work items of a cooperative task have been reassigned from a first processing unit to a second processing unit, wherein the first processing unit and the second processing unit are of a plurality of processing units;
calculating a chunk size using a victim equation in response to determining that one or more work items of the cooperative task have been reassigned from the first processing unit to the second processing unit; and
executing a set of work items of the cooperative task that correspond to the calculated chunk size.

18. The non-transitory processor-readable storage medium of claim 17, having stored thereon processor-executable instructions configured to cause a processor of a computing device to perform operations further comprising:
calculating the chunk size using a default equation in response to determining that no work items of the cooperative task have been reassigned from the first processing unit to the second processing unit;
wherein the default equation is:
$${T}^{′} = \frac{T}{x} ,$$
wherein T′ represents the chunk size, T represents a previously calculated chunk size, and x is a non-zero value.

19. The non-transitory processor-readable storage medium of claim 17, having stored thereon processor-executable instructions configured to cause a processor of a computing device to perform operations further comprising:
calculating the chunk size using a default equation in response to determining that no work items of the cooperative task have been reassigned from the first processing unit to the second processing unit;
wherein the default equation is:
$${T}^{′} = \frac{m}{( x * {2}^{n} )} ,$$
wherein T′ represents the chunk size, m represents a total number of work items assigned to the first processing unit, x is a non-zero value, and n is a counter representing a number of times the chunk size has been calculated for the first processing unit for the cooperative task.

20. The non-transitory processor-readable storage medium of claim 19, wherein n represents a total number of processing units executing work items of the cooperative task.

21. The non-transitory processor-readable storage medium of claim 17, wherein the victim equation is:
$${T}^{′} = int ( \frac{q}{p} * T ) ,$$
wherein T′ represents a new chunk size, int( ) represents a function that returns an integer value, T represents a previously-calculated chunk size, p represents a total number of remaining work items to be processed before a reassignment operation occurs, and q represents a number of remaining work items after the reassignment operation.

22. The non-transitory processor-readable storage medium of claim 17, wherein the cooperative task is a parallel loop task.

23. The non-transitory processor-readable storage medium of claim 17, wherein the plurality of processing units includes two or more of a first central processing unit (CPU), a second central processing unit (CPU), a graphics processing unit (GPU), and a digital signal processor (DSP).

24. The non-transitory processor-readable storage medium of claim 17, wherein the first processing unit and the second processing unit are the same processing unit that is executing two or more procedures that are each assigned different work items of the cooperative task.

25. A computing device, comprising:
means for determining whether any work items of a cooperative task have been reassigned from a first processing unit to a second processing unit, wherein the first processing unit and the second processing unit are of a plurality of processing units;
means for calculating a chunk size using a victim equation in response to determining that one or more work items of the cooperative task have been reassigned from the first processing unit to the second processing unit; and
means for executing a set of work items of the cooperative task that correspond to the calculated chunk size.

26. The computing device of claim 25, further comprising:
means for calculating the chunk size using a default equation in response to determining that no work items of the cooperative task have been reassigned from the first processing unit to the second processing unit;
wherein the default equation is:
$${T}^{′} = \frac{T}{x} ,$$
wherein T′ represents the chunk size, T represents a previously calculated chunk size, and x is a non-zero value.

27. The computing device of claim 25, further comprising:
means for calculating the chunk size using a default equation in response to determining that no work items of the cooperative task have been reassigned from the first processing unit to the second processing unit
$${T}^{′} = \frac{m}{( x * {2}^{n} )} ,$$
wherein T′ represents the chunk size, m represents a total number of work items assigned to the first processing unit, x is a non-zero value, and n is a counter representing a number of times the chunk size has been calculated for the first processing unit for the cooperative task.

28. The computing device of claim 27, wherein n represents a total number of processing units executing work items of the cooperative task.

29. The computing device of claim 25, wherein the victim equation is:
$${T}^{′} = int ( \frac{q}{p} * T ) ,$$
wherein T′ represents a new chunk size, int( ) represents a function that returns an integer value, T represents a previously-calculated chunk size, p represents a total number of remaining work items to be processed before a reassignment operation occurs, and q represents a number of remaining work items after the reassignment operation.

30. The computing device of claim 25, wherein the cooperative task is a parallel loop task.
